(19) United States
(12) Patent Application Publication
(10) Pub. No.: US 2007/0019615 A1
(43) Pub. Date: Jan. 25, 2007

(54) Home network system

(76) Inventors: Seung-Myun Baek, Kyungsangnam-Do (KR); Koon-Seok Lee, Kyungsangnam-Do (KR); Yong-Tae Kim, Kyungsangnam-Do (KR)

Correspondence Address: MCKENNA LONG & ALDRIDGE LLP, 1900 K STREET, NW, WASHINGTON, DC, 20006, US

(21) Appl. No.: 10/558,432

(22) PCT Filed: May 14, 2004
(86) PCT No.: PCT/KR04/01152

§ 371 Date: Nov. 29, 2005

(30) Foreign Application Priority Data
May 30, 2003 (KR) 10-2004-0034962
Mar. 31, 2004 (KR) 10-2004-0022208

(51) Int. Cl. H04L 12/66

(52) U.S. Cl. 370/352

(57) ABSTRACT

The present invention discloses a home network system (1) using a living network control protocol. The home network system (1) includes: at least two electric devices (41-49); and a network based on a predetermined protocol for connecting the electric devices (41-49), wherein a message transmitted between one electric device (41-49) and the other electric device (41-49) includes a command code field implying an operation that is to be performed by the other electric device (41-49), and an argument field according to a version of a protocol applied to one electric device (41-49) for performing the operation.

### TECHNICAL FIELD

The present invention relates to a home network system, and more particularly to, a home network system using a living network control protocol.

### BACKGROUND ART

A home network connects various digital home appliances so that the user can always enjoy convenient, safe and economic life services inside or outside the house. Refrigerators or washing machines called white home appliances have been gradually digitalized due to the development of digital signal processing techniques, home appliance operating system techniques and high speed multimedia communication techniques have been integrated on the digital home appliances, and new information home appliances have been developed, to improve the home network.

As shown in Table 1, the home network is classified into a data network, an entertainment network and a living network by types of services.

TABLE 1

| Classification | Function | Service type |
|---|---|---|
| Data network | Network between PC and | Data exchange, |
| | peripheral devices | internet service, etc. |
| Entertainment | Network between A/V | Music, animation service, etc. |
| network | devices | |
| Living network | Network for controlling | Home appliances control, |
| | home appliances | home automation, |
| | | remote meter reading, |
| | | message service, etc. |

Here, the data network is built to exchange data between a PC and peripheral devices or provide an internet service, and the entertainment network is built between home appliances using audio or video information. In addition, the living network is built to simply control home appliances, such as home automation or remote meter reading.

A conventional home network system includes a master device which is an electric device for controlling an operation of the other electric devices or monitoring a status thereof, and a slave device which is an electric device having a function of responding to the request of the master device and a function of notifying a status change according to characteristics of the electric devices or other factors. Exemplary electric devices include home appliances for the living network service such as a washing machine and a refrigerator, home appliances for the data network service and the entertainment network service, and products such as a gas valve control device, an automatic door device and an electric lamp.

However, the conventional arts do not suggest a general communication standard for providing functions of controlling and monitoring electric devices in a home network system.

### DISCLOSURE OF THE INVENTION

The present invention is achieved to solve the above problems. An object of the present invention is to provide a home network system using a control protocol which is a general communication standard for providing functions of controlling and monitoring electric devices in the home network system.

Another object of the present invention is to provide a home network system using a living network control protocol as a general communication standard.

Yet another object of the present invention is to provide a home network system which can process different command codes and resultant arguments according to a version of a living network control protocol.

Yet another object of the present invention is to provide a home network system which can perform various control operations by extending arguments by command codes according to a version of a living network control protocol.

In order to achieve the above-described objects of the invention, there is provided a home network system including: at least two electric devices; and a network based on a predetermined protocol for connecting the electric devices, wherein a message transmitted between one electric device and the other electric device includes a command code field implying an operation that is to be performed by the other electric device, and an argument field according to a version of a protocol applied to one electric device for performing the operation.

Preferably, the other electric device receives the message, extracts arguments from the argument field according to a version of a protocol applied to the other electric device for performing the operation, and processes the arguments.

Preferably, the other electric device discards arguments which are not extracted from the argument field.

Preferably, when arguments included in the argument field of the message are deficient, the other electric device sets the deficient arguments as predetermined values.

Preferably, the protocol is a living network control protocol (LnCP).

According to one aspect of the present invention, there is provided an electric device based on a predetermined protocol including at least a lower layer and an upper layer, wherein the upper layer receives from the lower layer a message including a command code field implying an operation that is to be performed by the electric device, and an argument field according to a version of a protocol applied to the electric device for performing the operation, extracts a command code from the message, extracts arguments from the argument field according to the version of the protocol applied to the electric device for executing the command code, and executes the command code.

According to another aspect of the present invention, there is provided a method for processing a message in a home network system, the home network system including at least two electric devices, and a network based on a predetermined protocol for connecting the electric devices, the method including the steps of generating and transmitting, at one electric device, a message including a command code field implying an operation that is to be performed by the other electric device, and an argument field according to a version of a protocol applied to one electric device for performing the operation; extracting, at the other electric device, a command code from the message; extracting, at the other electric device, arguments from the argument field according to a version of a protocol applied to the other electric device for executing the command code; and executing, at the other electric device, the command code.

According to yet another aspect of the present invention, there is provided a storage means for storing a message structure in a home network system, the home network system including at least two electric devices, and a network based on a predetermined protocol for connecting the electric devices, wherein a message transmitted in the home network system includes a command code field and an argument field for executing the command code, and the argument field is varied according to a version of a protocol applied to the electric device.

### BRIEF DESCRIPTION OF THE DRAWINGS

FIG. 1 is a structure view illustrating a home network system in accordance with the present invention;

FIG. 2 is a structure view illustrating a living network control protocol stack in accordance with the present invention;

FIGS. 3A and 3B are structure views illustrating interfaces between layers of FIG. 2, respectively;

FIGS. 4A to 4F are detailed structure views illustrating the interfaces of FIGS. 3a and 3b, respectively;

FIGS. 5A to 5C are structure views illustrating request messages;

FIGS. 6A to 6C are structure views illustrating response messages;

FIG. 7 is a structure view illustrating an event message; and

FIGS. 8A and 8B are structure views illustrating first and second examples of messages by versions of the LnCP in accordance with the present invention.

### BEST MODE FOR CARRYING OUT THE INVENTION

A home network system in accordance with the present invention will now be described in detail with reference to the accompanying drawings.

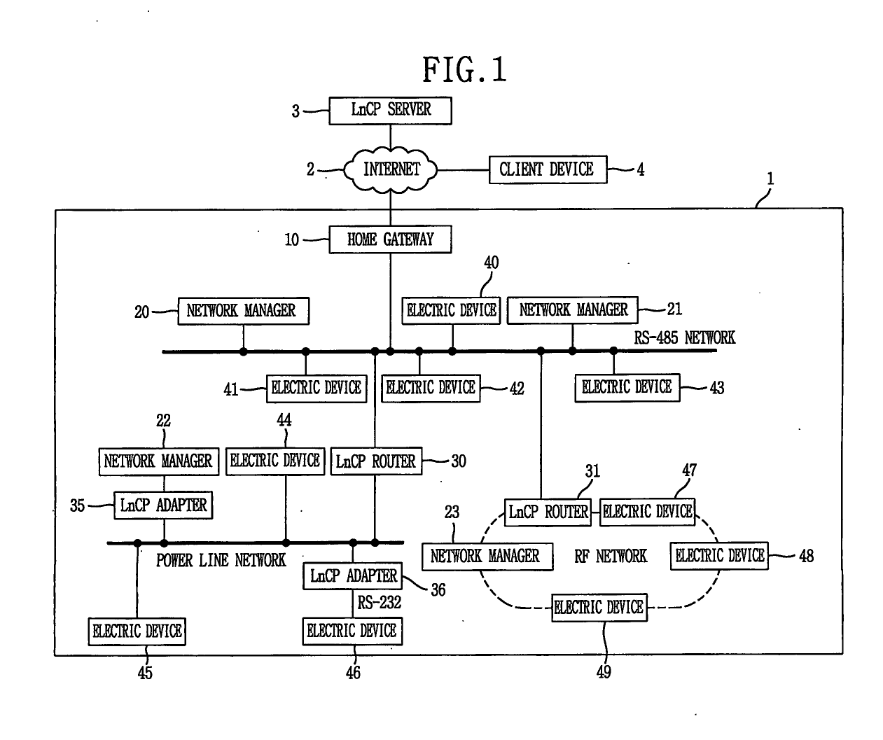

FIG. 1 is a structure view illustrating the home network system in accordance with the present invention.

Referring to FIG. 1, the home network system 1 accesses an LnCP server 3 through an internet 2, and a client device 4 accesses the LnCP server 3 through the internet 2. That is, the home network system 1 is connected to communicate with the LnCP server 3 and/or the client device 4.

An external network of the home network system 1 such as the internet 2 includes additional constitutional elements according to a kind of the client device 4. For example, when the client device 4 is a computer, the internet 2 includes a Web server (not shown), and when the client device 4 is an Internet phone, the internet 2 includes a Wap server (not shown).

The LnCP server 3 accesses the home network system 1 and the client device 4 according to predetermined login and logout procedures, respectively, receives monitoring and control commands from the client device 4, and transmits the commands to the network system 1 through the internet 2 in the form of predetermined types of messages. In addition, the LnCP server 3 receives a predetermined type of message from the home network system 1, and stores the message and/or transmits the message to the client device 4. The LnCP server 3 also stores or generates a message, and transmits the message to the home network system 1. That is, the home network system 1 accesses the LnCP server 3 and downloads provided contents.

The home network system 1 includes a home gateway 10 for performing an access function to the internet 2, network managers 20 to 23 for performing a function of setting an environment and managing electric devices 40 to 49, LnCP routers 30 and 31 for access between transmission media, LnCP adapters 35 and 36 for connecting the network manager 22 and the electric device 46 to the transmission medium, and the plurality of electric devices 40 to 49.

The network of the home network system 1 is formed by connecting the electric devices 40 to 49 through a shared transmission medium. A data link layer uses a non-standardized transmission medium such as RS-485 or small output RF, or a standardized transmission medium such as a power line and IEEE 802.11 as the transmission medium.

The network of the home network system 1 is separated from the internet 2, for composing an independent network for connecting the electric devices through wire or wireless transmission medium. Here, the independent network includes a physically-connected but logically-divided network.

The home network system 1 includes master devices for controlling operations of the other electric devices 40 to 49 or monitoring statuses thereof, and slave devices having functions of responding to the request of the master devices and notifying their status change information. The master devices include the network managers 20 to 23, and the slave devices include the electric devices 40 to 49. The network managers 20 to 23 include information of the controlled electric devices 40 to 49 and control codes, and control the electric devices 40 to 49 according to a programmed method or by receiving inputs from the LnCP server 3 and/or the client device 4. Still referring to FIG. 1, when the plurality of network managers 20 to 23 are connected, each of the network managers 20 to 23 must be both the master device and the slave device, namely physically one device but logically the device (hybrid device) for simultaneously performing master and slave functions in order to perform information exchange, data synchronization and control with the other network managers 20 to 23.

In addition, the network managers 20 to 23 and the electric devices 40 to 49 can be connected directly to the network (power line network, RS-485 network and RF network) or through the LnCP routers 30 and 31 and/or the LnCP adapters 35 and 36.

The electric devices 40 to 49 and/or the LnCP routers 30 and 31 and/or the LnCP adapters 35 and 36 are registered in the network managers 20 to 23, and provided with intrinsic logical addresses by products (for example, 0x00, 0x01, etc.). The logical addresses are combined with product codes (for example, 0x02 of air conditioner and 0x01 of washing machine), and used as node addresses. For example, the electric devices 40 to 49 and/or the LnCP routers 30 and 31 and/or the LnCP adapters 35 and 36 are identified by the node addresses such as 0x0200 (air conditioner 1) and 0x0201 (air conditioner 2). A group address for identifying at least one electric device 40 to 49 and/or at least one LnCP router 30 and 31 and/or at least one LnCP adapter 35 and 36 at a time can be used according to a predetermined standard (all identical products, installation space of products, user, etc.). In the group address, an explicit group address is a cluster for designating a plurality of devices by setting an address option value (flag mentioned below) as 1, and an implicit group address designates a plurality of devices by filling the whole bit values of the logical addresses and/or the product codes with 1. Especially, the implicit group address is called a cluster code.

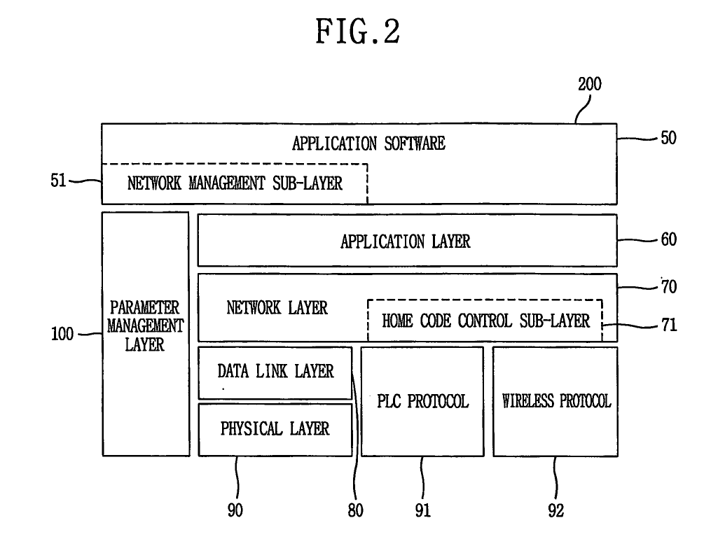

FIG. 2 is a structure view illustrating a living network control protocol stack in accordance with the present invention. The home network system 1 enables the network managers 20 to 23, the LnCP routers 30 and 31, the LnCP adapters 35 and 36 and the electric devices 40 to 49 to communicate with each other according to the living network control protocol (LnCP) of FIG. 2. Therefore, the network managers 20 to 23, the LnCP routers 30 and 31, the LnCP adapters 35 and 36 and the electric devices 40 to 49 perform network communication according to the LnCP.

As illustrated in FIG. 2, the LnCP includes an application software 50 for performing intrinsic functions of the network managers 20 to 23, the LnCP routers 30 and 31, the LnCP adapters 35 and 36 and the electric devices 40 to 49, and providing an interface function with an application layer 60 for remote controlling and monitoring on the network, the application layer 60 for providing services to the user, and also providing a function of forming information or a command from the user in the form of a message and transmitting the message to the lower layer, a network layer 70 for reliably network-connecting the network managers 20 to 23, the LnCP routers 30 and 31, the LnCP adapters 35 and 36 and the electric devices 40 to 49, a data link layer 80 for providing a medium access control function of accessing a shared transmission medium, a physical layer 90 for providing physical interfaces between the network managers 20 to 23, the LnCP routers 30 and 31, the LnCP adapters 35 and 36 and the electric devices 40 to 49, and rules for transmitted bits, and a parameter management layer 100 for setting and managing node parameters used in each layer.

In detail, the application software 50 further includes a network management sub-layer 51 for managing the node parameters, and the network managers 20 to 23, the LnCP routers 30 and 31, the LnCP adapters 35 and 36 and the electric devices 40 to 49 which access the network. That is, the network management sub-layer 51 performs a parameter management function of setting or using the node parameter values through the parameter management layer 100, and a network management function of composing or managing the network when the device using the LnCP is a master device.

When the network which the network managers 20 to 23, the LnCP routers 30 and 31, the LnCP adapters 35 and 36 and the electric devices 40 to 49 access is a dependent transmission medium such as a power line, IEEE 802.11 and wireless (for example, when the LnCP includes a PLC protocol and/or wireless protocol), the network layer 70 further includes a home code control sub-layer 71 for performing a function of setting, managing and processing home codes for logically dividing each individual network. When the individual networks are physically divided by an independent transmission medium such as RS-485, the home code control sub-layer 71 is not included in the LnCP. Each of the home codes is comprised of 4 bytes, and set as random values or designated values of the user.

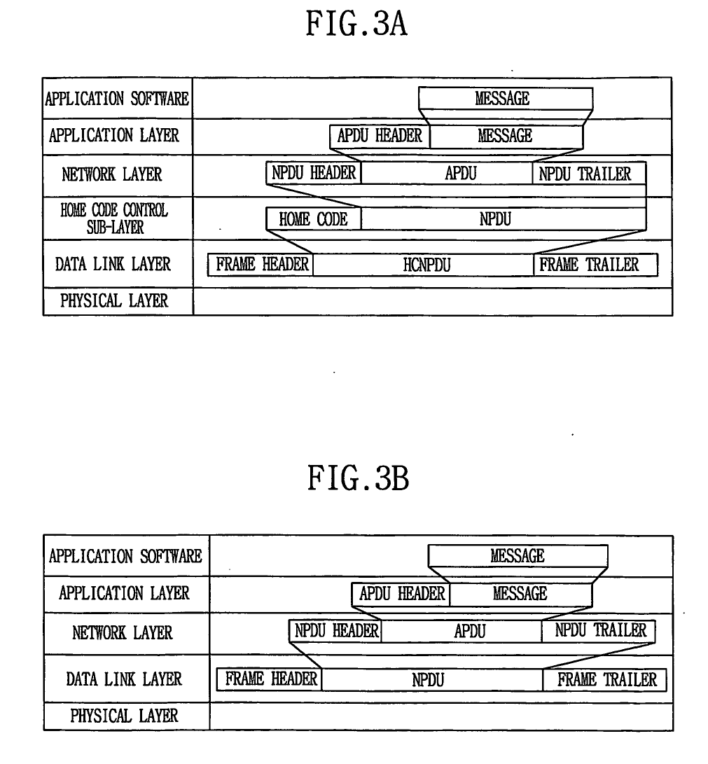

FIGS. 3A and 3B are structure views illustrating interfaces between the layers of FIG. 2, respectively.

FIG. 3A illustrates the interfaces between the layers when the physical layer 90 is connected to the dependent transmission medium, and FIG. 3B illustrates the interfaces between the layers when the physical layer 90 is connected to the independent transmission medium.

The home network system 1 adds headers and trailers required by each layer to protocol data units (PDU) from the upper layers, and transmit them to the lower layers.

As shown in FIGS. 3A and 3B, an application layer PDU (APDU) is a data transmitted between the application layer 60 and the network layer 70, a network layer PDU (NPDU) is a data transmitted between the network layer 70 and the data link layer 80 or the home code control sub-layer 71, and a home code control sub-layer PDU (HCNPDU) is a data transmitted between the network layer 70 (precisely, the home code control sub-layer 71) and the data link layer 80. The interface is formed in data frame units between the data link layer 80 and the physical layer 90.

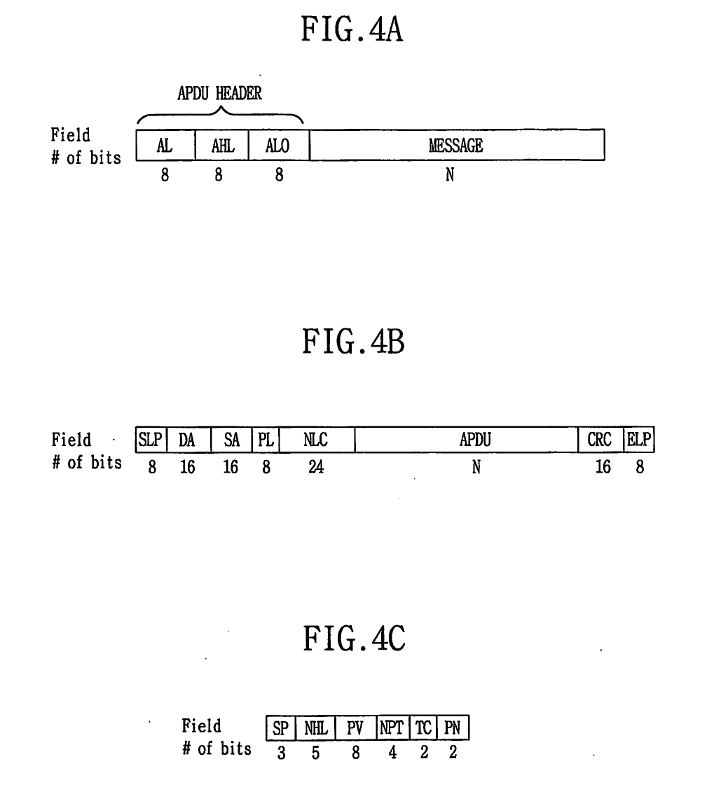

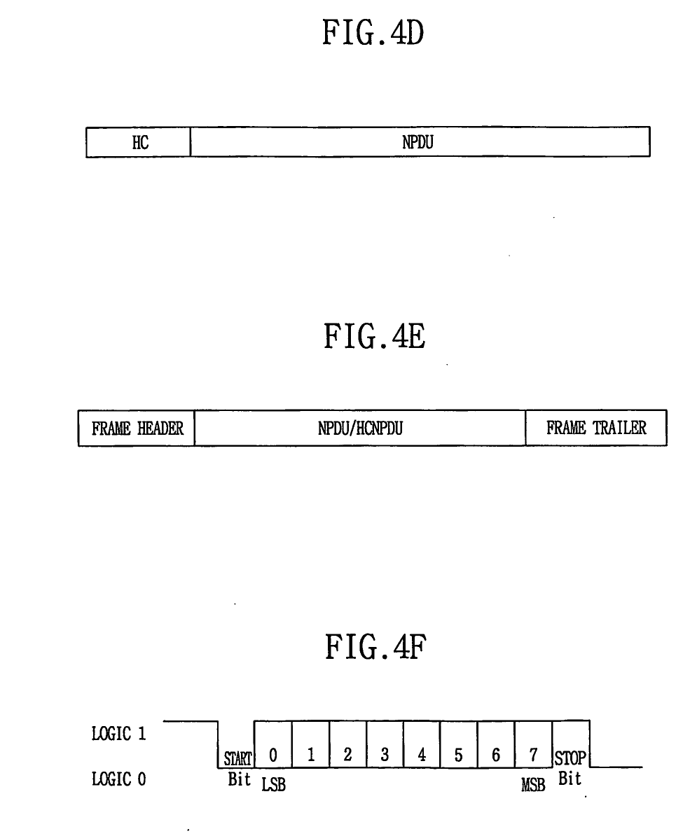

FIGS. 4A to 4F are detailed structure views illustrating the interfaces of FIGS. 3A and 3B, respectively.

FIG. 4A illustrates the APDU structure in the application layer 60.

An APDU length (AL) field shows a length of the APDU (length from AL to message field), and has a minimum value of 4 and a maximum value of 77.

An APDU header length (AHL) field shows a length of an APDU header (length from AL to ALO), normally has 3 bytes, and is extensible to 7 bytes. In the LnCP, the APDU header can be extended to 7 bytes to encode a message field and change an application protocol.

An application layer option (ALO) field extends a message set. For example, when the ALO field is set as 0, if the ALO field contains a different value, message processing is ignored.

The message field processes a control message from the user or event information, and is changed by the value of the ALO field.

FIG. 4B illustrates the NPDU structure in the network layer 70, and FIG. 4C illustrates a detailed NLC structure of the NPDU.

A start of LnCP packet (SLP) field shows start of a packet and has a value of 0x02.

Destination address (DA) and source address (SA) fields are node addresses of a receiver and a sender of a packet, and have 16 bits, respectively. The most significant 1 bit includes a flag indicating a group address, the succeeding 7 bits include a kind of a product (product code), and the lower 8 bits include a logical address for distinguishing the plurality of network managers 20 to 23 of the same kind and the plurality of electric devices 40 to 49 of the same kind.

A packet length (PL) field shows the whole length of the NPDU, and has a minimum value of 12 bytes and a maximum value of 100 bytes.

A service priority (SP) field gives transmission priority to a transmission message and has 3 bits. Table 2 shows the priority of each transmission message.

When a slave device responds to a request of a master device, the slave device takes the priority of the request message from the master device.

TABLE 2

| Priority | Value | Application layer |
|---|---|---|
| High | 0 | When an urgent message is transmitted |
| Middle | 1 | When a normal packet is transmitted |
| | | When an event message for online or offline status |
| | | change is transmitted |
| Normal | 2 | When a notification message for |
| | | composing a network is transmitted |
| | | When a normal event message is transmitted |
| Low | 3 | When a data is transmitted by download |
| | | or upload mechanism |

An NPDU header length (NHL) field extends an NPDU header (NLC field of SLP), normally has 9 bytes, and is extensible maximally to 16 bytes.

A protocol version (PV) field is an one-byte field showing a version of a used protocol. The upper 4 bits include a version field and the lower 4 bits include a sub-version field. The version and the sub-version are represented by the hexadecimal, respectively.

A network layer packet type (NPT) field is a 4-bit field for distinguishing a kind of a packet in the network layer 70. The LnCP includes a request packet, a response packet and a notification packet. The NPT field of a master device must be set as the request packet or the notification packet, and the NPT field of a slave device must be set as the response packet or the notification packet. Table 3 shows NPT values by kinds of packets.

TABLE 3

| Explanation | Value |
|---|---|
| Request packet | 0 |
| Not used | 1˜3 |
| Response packet | 4 |
| Not used | 5˜7 |
| Notification packet | 8 |
| Not used | 9˜12 |
| Reserved value for interface with the | 13˜15 |
| home code control sub-layer | |

A transmission counter (TC) field is a 2-bit field for retrying a request packet when the request packet or response packet is not successfully transmitted due to a communication error in the network layer 70, or repeatedly transmitting a notification packet to improve a transmission success ratio. A receiver can check a duplicate message by using a value of the TC field. Table 4 shows the range of the values of the TC field by the NPT values.

TABLE 4

| Kind of packet | Value (range) |
|---|---|
| Request packet | 1˜3 |
| Response packet | 1 |
| Notification packet | 1˜3 |

A packet number (PN) field has 2 bits, and is used to check a duplicate packet in a slave device with the TC field and process a plurality of communication cycles in a master device. Table 5 shows the range of the values of the PN field by the NPT values.

TABLE 5

| Kind of packet | Value (range) |
|---|---|
| Request packet | 0˜3 |
| Response packet | Copy a PN field value of a request packet |
| Notification packet | 0˜3 |

An APDU field is a protocol data unit of the application layer 60 transmitted between the application layer 60 and the network layer 70. The APDU field has a minimum value of 0 byte and a maximum value of 88 bytes.

A cyclic redundancy check (CRC) field is a 16-bit field for checking an error of a received packet (from SLP to APDU).

An end of LnCP packet (ELP) field shows end of a packet and has a value of 0x03. Although a data corresponding to the length of the PL field is received, if the ELP field is not checked, it is deemed to be a packet error.

FIG. 4D illustrates the HCNPDU structure in the home code control sub-layer 71.

As depicted in FIG. 4D, a home code (HC) field is added to the upper portion of the NPDU.

The home code is comprised of 4 bytes, and has a unique value within the line distance where a packet can be transmitted.

FIG. 4E illustrates a frame structure in the data link layer 80.

The structure of the header and the trailer of the data link layer frame of the LnCP is changed according to transmission media. When the data link layer 80 uses a non-standardized transmission medium, the header and the trailer of the frame must have null fields, and when the data link layer 80 uses a standardized transmission medium, the header and the trailer of the frame are formed as prescribed by the protocol. An NPDU field i s a data unit transmitted from the upper network layer 70, and an HCNPDU field is a data unit obtained by adding 4 bytes of home code to the front portion of the NPDU, when the physical layer 90 is a dependent transmission medium such as a power line or IEEE 802.11. The data link layer 80 processes the NPDU and the HCNPDU in the same manner.

FIG. 4F illustrates a frame structure in the physical layer 90.

The physical layer 90 of the LnCP handles a function of transmitting and receiving a physical signal to a transmission medium. The data link layer 80 can use a non-standardized transmission medium such as RS-485 or small output RF or a standardized transmission medium such as a power line or IEEE. 802.11 as the physical layer 90 of the LnCP. The home network system 1 using the LnCP employs a universal asynchronous receiver and transmitter (UART) frame structure and a signal level of RS-232, so that the network managers 20 to 23 and the electric devices 40 to 49 can interface with RS-485, the LnCP routers 30 and 31 or the LnCP adapters 35 and 36. When the UART is connected between the devices by using a serial bus, the UART controls flow of bit signals on a communication line. In the LnCP, a packet from the upper layer is converted into 10 bits of UART frame unit as shown in FIG. 4f, and transmitted through the transmission medium. The UART frame includes one bit of start bit, 8 bits of data and one bit of stop bit, and does not use a parity bit. The UART frame is transmitted in the order of the start bit to stop bit When the home network system 1 using the LnCP employs the UART, it does not have additional frame header and frame trailer.

In the arrangement of the byte (or bit) data in the above message, upper bytes (or bits) are positioned at the left side of the message, and lower bytes (or bits) are positioned at the right side of the message. The following kinds of messages are dealt in the application layer 60.

*Request message: Message transmitted from the application layer 60 to the network layer 70 in t he m aster device or from the network layer 70 to t he application layer 60 in t he slave device, for executing a command in the slave device. The application layer 60 of the slave device can respond to the request message in the form of a response message according to a transmission mode transmitted from the network layer 70.

*Response message : Message transmitted from the network layer 70 to the application layer 60 in the master device or from the application layer 60 to the network layer 70 in the slave device, for notifying a command execution result of the slave device. The response message is a response to a request message.

*Event message : Message transmitted from the application layer to the network layer in the transmission side or from the network layer to the application layer in the reception side, when the status of the device is changed. The reception side does not respond.

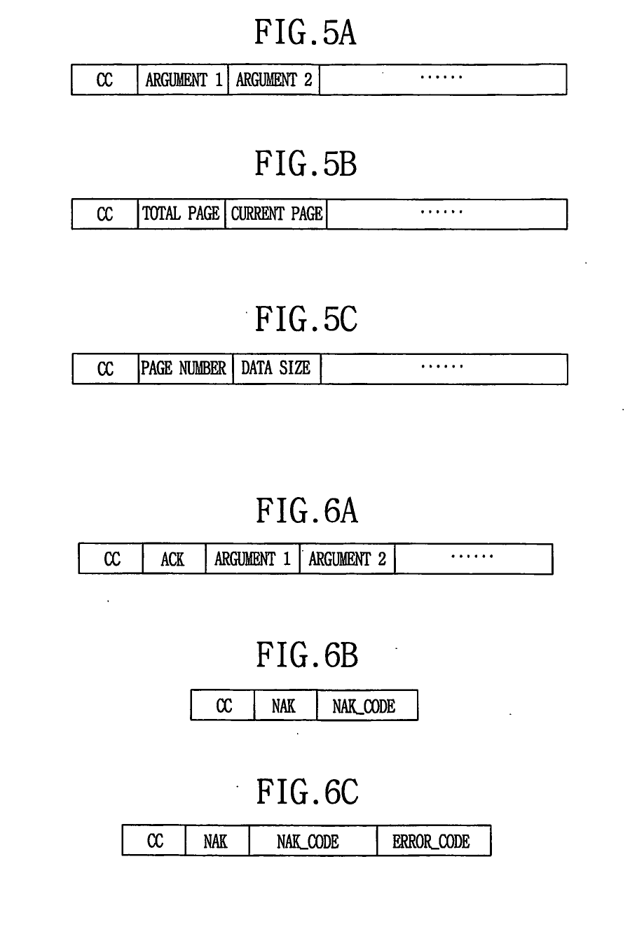

FIGS. 5A to 5C are structure views illustrating the request messages.

FIG. 5A shows a basic request message. The request message includes a command code (CC) and related arguments (argument 1, 2, . . . ) for executing the command code, and is used to request device control, status confirmation and device information confirmation.

FIG. 5B shows a downloading request message including a total page and a current page as input arguments for dividing a data and transmitting the data to the device, and FIG. 5C is an uploading request message including a page number and a data size as input arguments for getting a data from the device by division.

In detail, the downloading request message is used when the master device holds a predetermined data and transmits the data to the slave device and/or another master device. When the data is divided by a predetermined data size, the total number of the divided data is the total page, and the data included in the current request message in the total page is the current page.

The uploading request message is used when the slave device and/or another master device holds a predetermined data and the master device uploads the data. The master device requests some data corresponding to the data size in the whole data, and some data is the divided data existing in the order corresponding to the page number in the whole data.

FIGS. 6A to 6C are structure views illustrating the response messages.

The response messages are divided into an ACK-response message generated when the request message from the master device has been normally executed, and a NAK-response message generated when the request message from the master device has not been normally executed.

FIG. 6A shows the ACK-response message. The ACK-response message includes a command code, ACK (for example, 0x06) and arguments (argument 1, 2, . . . ) for notifying an execution result. The ACK-response message is used when the slave device successfully performs the request message from the master device.

FIG. 6B shows the NAK-response message. The NAK-response message includes a command code, NAK (for example, 0x15) and one byte of NAK₁₃code. The NAK-response message is used when the slave device does not successfully perform the request message from the master device. Here, NAK₁₃code is a code value for classifying reasons why the slave device does not successfully perform the request message due to a wrong command code or argument in the communication between the maser device and the slave device, and distinguished from an error relating to the product operation.

FIG. 6C shows a NAK-response message including Error₁₃code. Here, Error₁₃code denotes an error relating to the product operation. In the case that the slave device does not successfully perform the request message due to the error, NAK₁₃code is fixed to a predetermined value, for example, 0x63, and Error₁₃code follows NAK₁₃code.

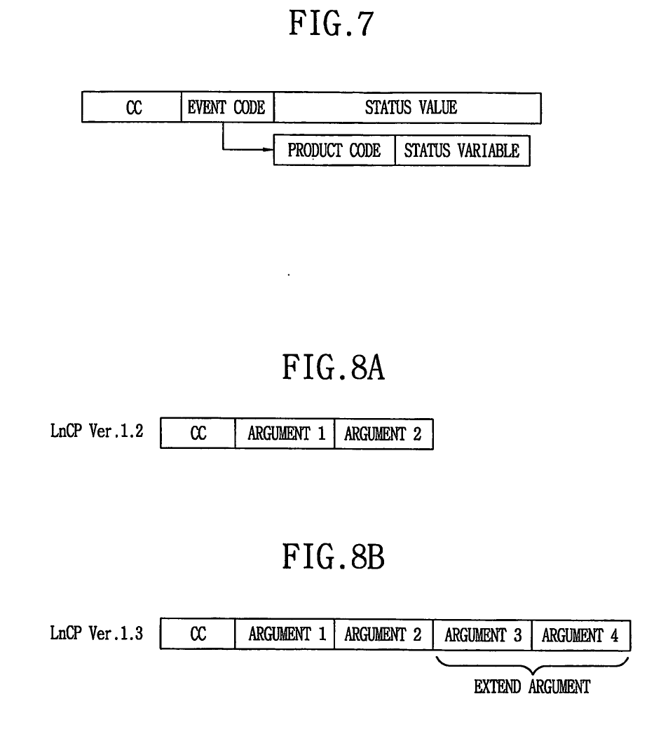

FIG. 7 is a structure view illustrating the event message.

Referring to FIG. 7, the event message is generated when the status of the device is changed, and includes a command code (for example, 0x11), an event code (2 bytes) and a status value (4 bytes). In the event code, an upper one byte is identical to a product code, and a lower one byte implies a status variable.

In accordance with the present invention, the messages dealt in the application layer 60 support upgradability for adding functions in an upper version of the LnCP, and compatibility between a device based on an upper version of the LnCP and a device based on a lower version of the LnCP.

FIGS. 8A and 8B are structure views illustrating first and second examples of messages by versions of the LnCP in accordance with the present invention.

As illustrated in FIG. 8A, in the LnCP version 1.2, the message includes a command code and arguments 1 and 2 for executing the command code.

Conversely, as shown in FIG. 8B, in the LnCP version 1.3, the message includes a command code having the same shape as the command code of FIG. 8A, and arguments 1 to 4 for executing the command code.

In the LnCP of the present invention, in order to achieve upgradability and compatibility, the upper version of the LnCP can add extend arguments (namely, arguments 3 and 4) for new functions behind the lowest input argument of the request message or the lowest return argument of the response message. That is, the message using the LnCP includes an argument field varied by the version of the LnCP. The added extend arguments must be recognized by the device based on the upper version of the LnCP, and ignored by the device based on the lower version of the LnCP.

When a device using a predetermined version of LnCP receives a message through the network, the device firstly extracts a command code from the message, extracts predetermined arguments according to the version of the LnCP applied to the device, discards the remaining arguments if they exist, and executes a predetermined command by using the extracted command code and arguments.

For example, when the device u sing the LnCP version 1.2 receives the message of FIG. 8B from the device using the LnCP version 1.3 through the network, the application layer 60 of the device firstly extracts the command code, decides that only arguments 1 and 2 are necessary in the LnCP version 1.2 applied to the device, extracts arguments 1 and 2 from arguments 1 to 4, and discards arguments 3 and 4. Accordingly, the device does not perform an operation by the extend arguments, namely arguments 3 and 4.

Conversely, when the device using the LnCP version 1.3 receives the message of FIG. 8A from the device using the LnCP version 1.2 through the network, the application layer 60 of the device firstly extracts the command code, and decides that arguments 1 to 4 corresponding to the command code are necessary in the LnCP version 1.3 applied to the device. However, the message merely has arguments 1 and 2. Therefore, the application layer 60 sets the extend arguments which are non-extracted arguments 3 and 4 as initial values (for example, the extend arguments are set as 0 not to perform a related operation, or different default values to perform a basic operation), and executes a predetermined operation by the command code.

The extend arguments are divided into a field included in the LnCP and a field which is not included in the LnCP for the intrinsic functions of the product manufacturer.

The extend argument included in the LnCP is an extendable message. Exemplary extendable messages include request messages and response messages of a read service for getting a data from the slave device.

The extend argument which is not included in the LnCP and is arbitrarily defined for the intrinsic functions of the product manufacturer is an invariable message. Exemplary invariable messages include response messages of a write service for setting a data in the slave device such as control and event messages.

As discussed earlier, the present invention provides the home network system using the control protocol which is the general communication standard for providing the functions of controlling and monitoring the electric devices in the home network system.

In addition, the present invention provides the home network system using the LnCP as the general communication standard.

Furthermore, the present invention provides the home network system which can process different command codes and resultant arguments according to the version of the LnCP.

The present invention provides the home network system which can perform various control operations by extending the arguments by the command codes according to the version of the LnCP.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A home network system, comprising:
at least two electric devices; and
a network based on a predetermined protocol for connecting the electric devices,
wherein a message transmitted between one electric device and the other electric device comprises a command code field implying an operation that is to be performed by the other electric device, and an argument field according to a version of a protocol applied to one electric device for performing the operation.

2. The system of claim 1, wherein the other electric device receives the message, extracts arguments from the argument field according to a version of a protocol applied to the other electric device for performing the operation, and processes the arguments.

3. The system of claim 2, wherein the other electric device discards arguments which are not extracted from the argument field.

4. The system of claim 2, wherein, when arguments included in the argument field of the message are deficient, the other electric device sets the deficient arguments as predetermined values.

5. The system of claim 1, wherein the protocol is a living network control protocol (LnCP).

6. An electric device based on a predetermined protocol including at least a lower layer and an upper layer,
wherein the upper layer receives from the lower layer a message including a command code field implying an operation that is to be performed by the electric device, and an argument field according to a version of a protocol applied to the electric device for performing the operation, extracts a command code from the message, extracts arguments from the argument field according to the version of the protocol applied to the electric device for executing the command code, and executes the command code.

7. The system of claim 6, wherein the upper layer discards arguments which are not extracted from the argument field.

8. The system of claim 6, wherein, when arguments included in the argument field of the message are deficient, the upper layer sets the deficient arguments as predetermined values.

9. The system of claim 6, wherein the protocol is a living network control protocol (LnCP).

10. A method for processing a message in a home network system, the home network system including at least two electric devices, and a network based on a predetermined protocol for connecting the electric devices, the method comprising the steps of:
generating and transmitting, at one electric device, a message including a command code field implying an operation that is to be performed by the other electric device, and an argument field according to a version of a protocol applied to one electric device for performing the operation;
extracting, at the other electric device, a command code from the message;
extracting, at the other electric device, arguments from the argument field according to a version of a protocol applied to the other electric device for executing the command code; and
executing, at the other electric device, the command code.

11. The method of claim 10, further comprising a step for discarding, at the other electric device, arguments which are not extracted from the argument field.

12. The method of claim 10, further comprising a step for setting deficient arguments as predetermined values, when arguments included in the argument field of the message are deficient.

13. The method of claim 10, wherein the protocol is a living network control protocol (LnCP).

14. A storage means for storing a message structure in a home network system, the home network system including at least two electric devices, and a network based on a predetermined protocol for connecting the electric devices,
wherein a message transmitted in the home network system comprises a command code field and an argument field for executing the command code, and the argument field is varied according to a version of a protocol applied to the electric device.

15. The storage medium of claim 14, wherein, when the version of the protocol applied to the electric device is the lowest version, the argument field comprises only a basic argument field for the version of the protocol.

16. The storage medium of either claim 14 or 15, wherein, when a lower version of the version of the protocol applied to the electric device exists, the argument field comprises a basic argument field for the lower version of the version of the protocol, and an extend argument field for the version of the protocol.

17. The storage medium of claim 16, wherein the message including the extend argument field is an extendable message included in the protocol, or an invariable message which is not included in the protocol but is defined for the intrinsic functions of the manufacturer.

18. The storage medium of claim 14, wherein the protocol is a living network control protocol (LnCP).
